(19) United States
(12) Patent Application Publication
(10) Pub. No.: US 2022/0386612 A1
(43) Pub. Date: Dec. 8, 2022

(54) TEBUCONAZOLE FORMULATIONS

(71) Applicant: Dow Global Technologies LLC, Mildland, MI (US)

(72) Inventors: Daniel F. Zweifel, Hirzel (CH); Evelyn A. Zaugg-Hoozemans, Horgen (CH)

(21) Appl. No.: 17/773,635

(22) PCT Filed: Jan. 28, 2021
(86) PCT No.: PCT/US2021/015480

§ 371 Date: May 2, 2022

Related U.S. Application Data
(60) Provisional application No. 62/970,929, filed on Feb. 6, 2020.

(51) Int. Cl. A01N 43/653; A01N 25/04

(52) U.S. Cl. CPC A01N 43/653; A01N 25/04

(57) ABSTRACT

A formulation includes (a) tebuconazole, (b) an emulsifier and (c) a solvent blend. The solvent blend includes (i) a first solvent, wherein the first solvent is Water-Immiscible and the first solvent has a first tebuconazole solubility as measured according to Solubility Testing and (ii) a second solvent having a miscibility with water greater than 5 wt % as measured according to ASTM D1722 at 23° C. The formulation has a formulation tebuconazole solubility greater than the first tebuconazole solubility as measured according to Solubility Testing.

### BACKGROUND

### Field of the Invention

The present disclosure generally relates to formulations, and more specifically, to formulations comprising tebuconazole.

### INTRODUCTION

Tebuconazole is a triazole fungicide used agriculturally to treat plant pathogenic fungi. The effectiveness of tebuconazole application to plants is increased when tebuconazole is mixed in a liquid in order to facilitate spraying of the tebuconazole on plants. Tebuconazole has a solubility of less than 0.1 g per liter in water at 20° C. Due to the low solubility, mixtures of tebuconazole and water or water-miscible solvent blends tend to precipitate the tebuconazole rending the mixture agriculturally useless. Accordingly, water-based mixtures comprising tebuconazole typically require water-immiscible solvents, emulsifiers and additives in order to form a stable emulsion that resists tebuconazole precipitation or separation.

Tebuconazole is a weakly polar compound. The weak polarity of tebuconazole results in water solubility that is too low to be agriculturally effective without a water-immiscible solvent, but polar enough to complicate water-immiscible solvent selection. As a result, conventional approaches to addressing the shortcomings of tebuconazole have relied on specialty water-immiscible solvents that introduce additional problems. For example, conventional water-immiscible solvents used with tebuconazole include fatty acid dimethylamide chemistry, which is relatively expensive, or cyclohenxanol, which has a pungent odor. Another conventional approach to addressing tebuconazole's shortcomings is to form specialty emulsion concentrates. For example, WO2008069822A1 discloses a tebuconazole emulsion formulation using a specialty amide solvent in combination with a non-ionic emulsifier and an anionic emulsifier. As explained by WO2008069822A1, the cost of emulsifying agents for tebuconazole is a significant factor in the total cost, and therefore in the utility, of the resulting composition.

In view of the foregoing, it would be surprising and unexpected to discover a tebuconazole emulsion concentrate using a simple and inexpensive solvent based formulation.

### SUMMARY OF THE DISCLOSURE

The present disclosure provides a tebuconazole emulsion concentrate using a simple and inexpensive solvent based formulation.

The present invention is a result of discovering that certain combinations of water-immiscible solvents and water-miscible solvents can be used to form stable emulsion concentrates comprising tebuconazole. As used herein, a solvent is water-miscible if it has a miscibility with water of greater than 5 wt % as measured according to ASTM D1722 at 23° C. As used herein. “Water-Immiscible” solvents cannot be added to water at a concentration greater than 5 wt % of the combined weight of the solvent and water at 23° C. without causing turbidity and/or separation in the solvent and water combination. The present invention is surprising in that despite tebuconazole having a low solubility in water-miscible solvents, the inventors have discovered that the addition of some water-miscible solvents actually increases the solubility of tebuconazole in water-immiscible solvents while also maintaining stability. The combination of solvents is advantageous in that not only can the formulation comprises similar tebuconazole concentrations as conventional formulations, but the use of relatively inexpensive solvents as opposed to multiple emulsifiers provides a cost advantage to such formulations.

The present invention is particularly useful for agricultural compositions.

According to a first feature of the present disclosure, a formulation includes (a) tebuconazole, (b) an emulsifier and (c) a solvent blend. The solvent blend includes (i) a first solvent, wherein the first solvent is Water-Immiscible and the first solvent has a first tebuconazole solubility as measured according to Solubility Testing and (ii) a second solvent having a miscibility with water greater than 5 wt % as measured according to ASTM D1722 at 23° C. The formulation has a formulation tebuconazole solubility greater than the first tebuconazole solubility as measured according to Solubility Testing. According to a second feature of the present disclosure, the first solvent comprises one of (i) 2,2,4-trimethyl-1,3-pentanediol monoisobutyrate, (ii) n-butyl acetate, (iii) methyl isobutyl ketone and (iv) combinations thereof. According to a third feature of the present disclosure, the second solvent comprises one of (i) propylene glycol n-propyl ether, (ii) methyl ethyl ketone, (iii) methanol, (iv) 1-propanol, (v) propylene glycol monomethyl ether and (vi) combinations thereof. According to a fourth feature of the present disclosure, the solvent blend comprises one of (i) 2,2,4-trimethyl-1,3-pentanediol monoisobutyrate and methanol, (ii) methyl isobutyl ketone and propylene glycol monomethyl ether, or (iii) n-butyl Acetate and propylene glycol monomethyl ether. According to a fifth feature of the present disclosure, the formulation comprises from 20 wt % to 30 wt % tebuconazole based on a total weight of the formulation. According to a sixth feature of the present disclosure, the formulation comprises from 5 wt % to 15 wt % of an emulsifier based on a total weight of the formulation and from 55 wt % to 75 wt % solvent blend based on a total weight of the formulation. According to a seventh feature of the present disclosure, the solvent blend comprises from 40 wt % to 50 wt % of the first solvent based on a total weight of the formulation and 15 wt % to 25 wt % of the second solvent based on a total weight of the formulation. According to an eight feature of the present disclosure, an emulsion comprises water and the formulation of any of the preceding features.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated. Parts per million (ppm) refers to weight parts based on total aqueous solution weight unless otherwise indicated. Subscript values in polymer formulae refer to mole average number of units per molecule for the designated component of the polymer.

As used herein, a “wt %” or “weight percent” or “percent by weight” of a component, unless specifically stated to the contrary, is based on the total weight of the composition or article in which the component is included. As used herein, all percentages are by weight unless indicated otherwise.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

### Formulation

The present disclosure is directed to a formulation. The formulation comprises tebuconazole, a solvent blend and an emulsifier. The solvent blend comprises a first solvent and a second solvent. The formulation may be useful as an emulsion concentrate or for forming an emulsion.

### Tebuconazole

The formulation comprises tebuconazole. The International Union of Pure and Applied Chemistry (IUPAC) name of tebuconazole is 1-(4-chlorophenyl)-4,4-dimethyl-3-(1H-1,2,4-triazol-1-ylmethyl)-3-pentanol. Tebuconazole is available under the chemical abstracts service registry (CAS) number of 107534-96-3 from Sigma-Aldrich, St. Louis, Mo., USA.

The formulation may comprise from 10 weight percent (wt %) to 40 wt % of tebuconazole based on a total weight of the formulation. For example, the formulation may comprise 10 wt % or greater, or 12 wt % or greater, or 14 wt % or greater, or 16 wt % or greater, or 18 wt % or greater, or 20 wt % or greater, or 22 wt % or greater, or 24 wt % or greater, or 26 wt % or greater, or 28 wt % or greater, or 30 wt % or greater, or 32 wt % or greater, or 34 wt % or greater, or 36 wt % or greater, or 38 wt % or greater, while at the same time, 40 wt % or less, or 38 wt % or less, or 36 wt % or less, or 34 wt % or less, or 32 wt % or less, or 30 wt % or less, or 28 wt % or less, or 26 wt % or less, or 24 wt % or less, or 22 wt % or less, or 20 wt % or less, or 18 wt % or less, or 16 wt % or less, or 14 wt % or less, or 12 wt % or less tebuconazole based on the total weight of the formulation.

### Emulsifier

The formulation may comprise one or more emulsifiers. As used herein, an “emulsifier” is defined as an amphiphilic material that reduces interfacial energy between two or more low miscibility phases and contributes to the stabilization of dispersed droplets of one phase within another. Examples of emulsifiers suitable for use in the formulation include castor oil ethoxylates and secondary alcohol ethoxylates. Commercial examples of secondary ethoxylates suitable for use in the formulation include TERGITOL™ 15-S-9 surfactant (CAS number 84133-50-6) and TERGITOL™ 15-S-20 surfactant (CAS number 68131-40-8), both of which are available from The Dow Chemical Company, Midland, Mich. Commercial examples of ethoxylated castor oil suitable for the formulation include are available under the CAS number 61791-12-6 from Sigma-Aldrich, St. Louis, Mo., USA.

The formulation may comprise from 5 wt % to 15 wt % of the emulsifier based on the total weight of the formulation. For example, the formulation may comprise 5 wt % or greater, or 6 wt % or greater, or 7 wt % or greater, or 8 wt % or greater, or 9 wt % or greater, or 10 wt % or greater, or 11 wt % or greater, or 12 wt % or greater, or 13 wt % or greater, or 14 wt % or greater, while at the same time, 15 wt % or less, or 14 wt % or less, or 13 wt % or less, or 12 wt % or less, or 11 wt % or less, or 10 wt % or less, or 9 wt % or less, or 8 wt % or less, or 7 wt % or less, or 6 wt % or less of the emulsifier based on the total weight of the formulation.

### Solvent Blend

The formulation comprises from 50 wt % to 80 wt % of the solvent blend based on a total weight of the formulation. For example, the formulation may comprise 50 wt % or greater, or 52 wt % or greater, or 54 wt % or greater, or 56 wt % or greater, or 58 wt % or greater, or 60 wt % or greater, or 62 wt % or greater, or 64 wt % or greater, or 66 wt % or greater, or 68 wt % or greater, or 70 wt % or greater, or 72 wt % or greater, or 74 wt % or greater, or 76 wt % or greater, or 78 wt % or greater, while at the same time, 80 wt % or less, or 78 wt % or less, or 76 wt % or less, or 74 wt % or less, or 72 wt % or less, or 70 wt % or less, or 68 wt % or less, or 66 wt % or less, or 64 wt % or less, or 62 wt % or less, or 60 wt % or less, or 58 wt % or less, or 56 wt % or less, or 54 wt % or less, or 52 wt % or less of the solvent blend based on a total weight of the formulation.

The solvent blend comprises a first solvent and a second solvent. The first solvent is Water-Immiscible. As used herein, the term “Water-Immiscible” is defined to mean that the solvent in question (e.g., the first solvent) cannot be added to water at a concentration greater than 5 wt % of the combined weight of the solvent and water at 23° C. without causing turbidity and/or separation in the resulting combination. The turbidity and/or separation is determined visually.

The first solvent has a first tebuconazole solubility as measured according to Solubility Testing. Solubility Testing is carried out at 23° C. and in accordance with the test procedure laid in the examples section. The first tebuconazole solubility may be from 18 wt % to 24 wt % based on the combined weight of the first solvent and the tebuconazole. The first tebuconazole solubility may be 18.0 wt % or greater, or 18.5 wt % or greater, or 19.0 wt % or greater, or 19.5 wt % or greater, or 20.0 wt % or greater, or 20.5 wt % or greater, or 21.0 wt % or greater, or 21.5 wt % or greater, or 22.0 wt % or greater, or 22.5 wt % or greater, or 23.0 wt % or greater, or 23.5 wt % or greater, while at the same time, 24.0 wt % or less, or 23.5 wt % or less, or 23.0 wt % or less, or 22.5 wt % or less, or 22.0 wt % or less, or 21.5 wt % or less, or 21.0 wt % or less, or 20.5 wt % or less, or 20.0 wt % or less, or 19.5 wt % or less, or 19.0 wt % or less, or 18.5 wt % or less based on the combined weight of the first solvent and the tebuconazole.

The first solvent may comprise one of (i) 2,2,4-trimethyl-1,3-pentanediol monoisobutyrate, (ii) n-butyl acetate, (iii) methyl isobutyl ketone and (iv) combinations thereof. 2,2,4-trimethyl-1,3-pentanediol monoisobutyrate is commercially available under the CAS number 25265-77-4 from Sigma-Aldrich, St. Louis, Mo., USA. N-butyl acetate is commercially available under the CAS number 123-86-4 from Sigma-Aldrich, St. Louis, Mo., USA. Methyl isobutyl ketone is commercially available under the CAS number 108-10-1 from Sigma-Aldrich, St. Louis, Mo., USA.

The formulation may comprise from 40 wt % to 50 wt % of the first solvent based on the total weight of the formulation. For example, the formulation may comprise 40 wt % or greater, or 41 wt % or greater, or 42 wt % or greater, or 43 wt % or greater, or 44 wt % or greater, or 45 wt % or greater, or 46 wt % or greater, or 47 wt % or greater, or 48 wt % or greater, or 49 wt % or greater, while at the same time, 50 wt % or less, or 49 wt % or less, or 48 wt % or less, or 47 wt % or less, or 46 wt % or less, or 45 wt % or less, or 44 wt % or less, or 43 wt % or less, or 42 wt % or less, or 41 wt % or less of the first solvent based on a total weight of the formulation.

The second solvent has a miscibility with water of greater than 5 wt % as measured according to ASTM D1722 at 23° C. For example, the second solvent may have a miscibility with water of 10 wt % or greater, or 20 wt % or greater, or may be completely miscible with water.

The second solvent comprises one of (i) propylene glycol n-propyl ether, (ii) methyl ethyl ketone, (iii) methanol, (iv) 1-propanol, (v) propylene glycol monomethyl ether and (vi) combinations thereof. Propylene glycol n-propyl ether is available under the CAS number 1569-01-3 from Sigma-Aldrich, St. Louis, Mo., USA. Methyl ethyl ketone is available under the CAS number 78-93-3 from Sigma-Aldrich, St. Louis, Mo., USA. Methanol is available under the CAS number 67-56-1 from Sigma-Aldrich, St. Louis, Mo., USA. 1-propanol is available under the CAS number 71-23-8 from Sigma-Aldrich, St. Louis, Mo., USA. Propylene glycol monomethyl ether is available under the CAS number 107-98-2 from Sigma-Aldrich, St. Louis, Mo., USA.

The formulation may comprise from 10 wt % to 30 wt % of the second solvent based on the total weight of the formulation. For example, the formulation may comprise 10 wt % or greater, or 12 wt % or greater, or 14 wt % or greater, or 16 wt % or greater, or 18 wt % or greater, or 20 wt % or greater, or 22 wt % or greater, or 24 wt % or greater, or 26 wt % or greater, or 28 wt % or greater, while at the same time, 30 wt % or less, or 28 wt % or less, or 26 wt % or less, or 24 wt % or less, or 22 wt % or less, or 20 wt % or less, or 18 wt % or less, or 16 wt % or less, or 14 wt % or less, or 12 wt % or less of the second solvent based on a total weight of the formulation.

### Formulation Tebuconazole Solubility

The formulation has a formulation tebuconazole solubility. As defined herein, the “formulation tebuconazole solubility” is the maximum solubility of tebuconazole in the formulation based on the combined weight of emulsifier, solvent blend and tebuconazole as measured according to Solubility Testing. The formulation tebuconazole solubility is greater than the first tebuconazole solubility of the first solvent as measured according to Solubility Testing. Such a result is surprising and non-obvious because one would not expect the addition of a water-miscible solvent, a type of solvent that typically has a lower tebuconazole solubility than water-immiscible solvent, to increase the solubility of tebuconazole in the formulation. Accordingly, it is surprising that the formulation tebuconazole solubility is greater than the first tebuconazole solubility of the first solvent blend. The formulation has a formulation tebuconazole solubility of from 19 wt % to 28 wt % based on the total weight of the tebuconazole, solvent blend and emulsifier as measured according to Solubility Testing at 23° C. For example, the formulation tebuconazole solubility is 19.0 wt % or greater, or 19.5 wt % or greater, or 20.0 wt % or greater, or 20.5 wt % or greater, or 21.0 wt % or greater, or 21.5 wt % or greater, or 22.0 wt % or greater, or 22.5 wt % or greater, or 23.0 wt % or greater, or 23.5 wt % or greater, or 24.0 wt % or greater, or 24.5 wt % or greater, or 25.0 wt % or greater, or 25.5 wt % or greater, or 26.0 wt % or greater, or 26.5 wt % or greater, or 27.0 wt % or greater, or 27.5 wt % or greater, while at the same time, 28.0 wt % or less, or 27.5 wt % or less, or 27.0 wt % or less, or 26.5 wt % or less, or 26.0 wt % or less, or 25.5 wt % or less, or 25.0 wt % or less, or 24.5 wt % or less, or 24.0 wt % or less, or 23.5 wt % or less, or 23.0 wt % or less, or 22.5 wt % or less, or 22.0 wt % or less, or 21.5 wt % or less, or 21.0 wt % or less, or 20.5 wt % or less, or 20.0 wt % or less, or 19.5 wt % or less based on the total weight of the solvent blend, the emulsifier and the tebuconazole.

### Emulsions and Emulsion Concentrates

Emulsion concentrates are formulations that, when added to water, spontaneously form an emulsion with the water. Upon addition to water, the formulation spontaneously forms an emulsion in which the solvent blend is dispersed within the water as a plurality of discrete droplets. The tebuconazole is suspended within the droplets of the solvent blend and the emulsifier stabilizes the droplets of solvent blend within the water. The emulsion may be then sprayed or otherwise dispensed on crops or in an agricultural setting to disperse the tebuconazole.

### Examples

### Test Method

Solubility Testing: Solubility Testing is performed by first weighing out 7.4 grams (g) of either (1) the neat solvent or (2) a mixture of solvent blend and emulsifier in the appropriate ratio into a beaker on an analytical balance. Next, a magnetic stir bar within the beaker is activated to stir the contents of the beaker while tebuconazole is added. The tebuconazole is added to the solvent or mixture in 0.05 g to 0.10 g increments. The tebuconazole is added until the contents of the beaker visually appear turbid and saturated. Solubility Testing is performed at 23° C. with each of the materials and pieces of equipment being at 23° C. The results of the Solubility Testing are reported as the maximum wt % of tebuconazole in the (i) solvent and tebuconazole mixture or (ii) solvent blend, emulsifier and tebuconazole mixture that will be supported before turbidity is observed.

### Materials

The following materials are used in the Examples below.

Tebuconazole is 1-(4-chlorophenyl)-4,4-dimethyl-3-(1H-1,2,4-triazol-1-ylmethyl)-3-pentanol and is available under the CAS number of 107534-96-3 from Sigma-Aldrich, St. Louis, Mo., USA.

TPM is 2,2,4-trimethyl-1,3-pentanediol monoisobutyrate and is available under the CAS number 25265-77-4 from Sigma-Aldrich, St. Louis, Mo., USA.

MIBK is methyl isobutyl ketone and is available under the CAS number 108-10-1 from Sigma-Aldrich, St. Louis, Mo., USA.

PGPE is propylene glycol phenyl ether and is available under the CAS number 770-35-4 from Sigma-Aldrich, St. Louis, Mo., USA.

EGPE is ethylene glycol phenyl ether and is available under the CAS number 122-99-6 from Sigma-Aldrich, St. Louis, Mo., USA.

NBA is n-butyl acetate and is available under the CAS number 123-86-4 from Sigma-Aldrich, St. Louis, Mo., USA.

PGNPE is propylene glycol n-propyl ether and is available under the CAS number 1569-01-3 from Sigma-Aldrich, St. Louis, Mo., USA.

MEK is methyl ethyl ketone and is available under the CAS number 78-93-3 from Sigma-Aldrich, St. Louis, Mo., USA.

MeOH is methanol and is available under the CAS number 67-56-1 from Sigma-Aldrich, St. Louis, Mo., USA.

1-Prop is 1-propanol and is available under the CAS number 71-23-8 from Sigma-Aldrich, St. Louis, Mo., USA.

PGME is propylene glycol monomethyl ether and is available under the CAS number 107-98-2 from Sigma-Aldrich, St. Louis, Mo., USA.

Emulsifier is ethoxylated castor oil and is available under the CAS number 61791-12-6 from Sigma-Aldrich, St. Louis, Mo., USA.

### Results

Table 1 provides the concentrations of inventive examples (IE) and comparative examples (CE) of the formulation in addition to the tebuconazole solubilities of each. The relative tebuconazole solubility is measured by dividing the tebuconazole solubility of a (i) first solvent, (ii) second solvent and (iii) emulsifier formulation by the tebuconazole solubility of just the first solvent. The tebuconazole solubility is measured according to the Solubility Testing procedure laid out above.

TABLE 1

| | | First | | Second | | Tebuconazole | Relative |
|---|---|---|---|---|---|---|---|
| | First | Solvent | Second | Solvent | Emulsifier | Solubility | Tebuconazole |
| Example | Solvent | wt % | Solvent | wt % | (wt %) | (wt %) | solubility |
| CE1 | TPM | 81.82 | — | 0 | 0 | 18.18 | — |
| IE1 | TPM | 48.65 | PGNPE | 20.54 | 10.81 | 20.00 | 110% |
| IE2 | TPM | 48.91 | MEK | 20.65 | 10.87 | 19.57 | 108% |
| IE3 | TPM | 48.13 | MEOH | 20.32 | 10.70 | 20.86 | 115% |
| IE4 | TPM | 48.91 | 1-Prop | 20.65 | 10.87 | 19.57 | 108% |
| CE2 | MIBK | 76.92 | — | 0 | 0 | 23.08 | — |
| IE5 | MIBK | 43.90 | PGME | 18.54 | 9.76 | 27.8 | 120% |
| CE3 | PGPE | 75.00 | — | 0 | 0 | 25.00 | — |
| CE4 | PGPE | 46.63 | PGME | 19.69 | 10.36 | 23.32 | 93% |
| CE5 | EGPE | 72.30 | — | 0 | 0 | 27.70 | — |
| CE6 | EGPE | 45.45 | PGME | 19.19 | 10.10 | 25.25 | 91% |
| CE7 | NBA | 77.59 | — | 0 | 0 | 22.41 | — |
| IE6 | NBA | 44.12 | PGME | 18.63 | 0 | 27.45 | 122% |

As evident from Table 1, IE1-IE6 each demonstrate the surprising increase of tebuconazole solubility after the addition of a water-miscible second solvent. For example, the two-solvent formulations of IE1-IE4 each demonstrate an 8% to 15% increase in tebuconazole solubility over the comparative single water-immiscible solvent counterparts. Such a result is surprising because one would not expect that adding solvents having a miscibility with water greater than 5 wt %, a class of solvents generally having low tebuconazole solubilities, would increase the tebuconazole solubility of the formulation. As can be seen from CE3-CE6, not all additions of water-miscible solvents result in the formulation having a tebuconazole solubility greater than the tebuconazole solubility of the water-immiscible solvent. Such a result increases the unexpected nature of the present invention.

1. A formulation, comprising:
(a) tebuconazole;
(b) an emulsifier; and
(c) a solvent blend, comprising:
(i) a first solvent, wherein the first solvent is Water-Immiscible and the first solvent has a first tebuconazole solubility as measured according to Solubility Testing; and
(ii) a second solvent having a miscibility with water greater than 5 wt % as measured according to ASTM D1722 at 23° C., wherein the formulation has a formulation tebuconazole solubility greater than the first tebuconazole solubility as measured according to Solubility Testing.

2. The formulation of claim 1, wherein the first solvent comprises one of (i) 2,2,4-trimethyl-1,3-pentanediol monoisobutyrate, (ii) n-butyl acetate, (iii) methyl isobutyl ketone and (iv) combinations thereof.

3. The formulation of claim 1, wherein the second solvent comprises one of (i) propylene glycol n-propyl ether, (ii) methyl ethyl ketone,
(iii) methanol, (iv) 1-propanol, (v) propylene glycol monomethyl ether and (vi) combinations thereof.

4. The formulation of claim 1, wherein the solvent blend comprises one of (i) 2,2,4-trimethyl-1,3-pentanediol monoisobutyrate and methanol,
(ii) methyl isobutyl ketone and propylene glycol monomethyl ether, or (iii) n-butyl Acetate and propylene glycol monomethyl ether.

5. The formulation of claim 1, wherein the formulation comprises from 20 wt % to 30 wt % tebuconazole based on a total weight of the formulation.

6. The formulation of claim 1, wherein the formulation comprises from 5 wt % to 15 wt % of an emulsifier based on a total weight of the formulation and from 55 wt % to 75 wt % solvent blend based on a total weight of the formulation.

7. The formulation of claim 1, wherein the solvent blend comprises from 40 wt % to 50 wt % of the first solvent based on a total weight of the formulation and 15 wt % to 25 wt % of the second solvent based on a total weight of the formulation.

8. An emulsion, comprising water and the formulation of claim 1.
